(19) United States
(12) Patent Application Publication
(10) Pub. No.: US 2010/0058254 A1
(43) Pub. Date: Mar. 4, 2010

(54) Information Processing Apparatus and Information Processing Method

(76) Inventor: Tomoya NARITA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/550,079

(22) Filed: Aug. 28, 2009

(30) Foreign Application Priority Data
Aug. 29, 2008 (JP) P2008-221859

(51) Int. Cl. G06F 3/01

(52) U.S. Cl. 715/863

(57) ABSTRACT

To provide an information processing apparatus and information processing method capable of rapidly and easily zooming in or out an image displayed on a display unit. The apparatus includes a display unit 124 that displays an image on a screen based on image data, a proximity detection unit 122 that detects a contact or proximity between a contact object and the display unit, an angle detection unit 106 that detects a rotation of the display unit in a plane parallel to the screen of the display unit, and a zoom processing unit 172 that zooms in or out an element displayed on the screen of the display unit and displays the same on the screen depending on a rotation angle of the detected rotation while the contact or proximity is being detected.

### BACKGROUND OF THE INVENTION

1. Field of the Invention

The present invention relates to an information processing apparatus and information processing method.

2. Description of Related Art

An information processing apparatus such as personal computer, cell phone or PDA provides information to a user via a display device such as liquid crystal display. The information provided to the user includes character information or image data such as photographs or animations, for example. Further, various items of information are input from the user into the information processing apparatus via an operation member such as keyboard or buttons.

A display device includes a touch panel (touch screen) in which an electrostatic capacitance or resistive touch sensor is provided on a surface of a display unit such as liquid crystal display. With the touch panel, the user can touch the screen of the display unit to input information into the information processing apparatus so that the user can easily manipulate the information processing apparatus.

### SUMMARY OF THE INVENTION

When an information processing apparatus displays an image such as photograph on a display device, the information processing apparatus can zoom in or out the image through user's operation. In related art, the operation of zooming in or out the image (zoom operation) is realized through an operation by zoom button or operation by slide bar. However, typically when the zoom operation is input, the displayed image is subjected to zoom-in processing or zoom-out processing with reference to the center of the image.

Thus, when a target to be zoomed in is present at an edge of the image instead of the center of the image, an operation of moving the image has been needed in addition to the zoom operation. The operation of moving the image is realized through an operation by arrow keys or drag&drop. For example, in order to enlarge a target of interest and to move it to the center of the screen, the enlarged display by zoom operation and the movement of the target of interest by the moving operation have been alternately performed.

The present invention has been made in views of the above issues and it is desirable to provide a novel and improved information processing apparatus and information processing method capable of rapidly and easily zooming in or out an image displayed on a display unit.

According to an embodiment of the present invention, there is provided an information processing apparatus including: a display unit that displays an image on a screen based on image data; a proximity detection unit that detects a contact or proximity between a contact object and the display unit; an angle detection unit that detects a rotation of the display unit in a plane parallel to the screen of the display unit; and a zoom processing unit that zooms in or out an element displayed on the screen of the display unit and displays the same on the screen depending on a rotation angle of the detected rotation while the contact or proximity is being detected.

The zoom processing unit may zoom in or out the element with reference to a position of the detected contact or proximity on the screen.

The information processing apparatus may include a movement processing unit that moves an element displayed on the screen of the display unit and displays the same on the screen depending on a change in a position of the detected contact or proximity while the contact or proximity is being detected.

The information processing apparatus may include a rotation processing unit that rotates an element displayed on the screen of the display unit and displays the same on the screen depending on a rotation angle of the detected rotation while the contact or proximity is being detected.

When a predetermined time elapses after the proximity detection unit detects the contact or proximity, the zoom processing unit may start a zoom mode capable of zooming in or out the element.

Furthermore, according to another embodiment of the present invention, there is provided an information processing method including the steps of: displaying an image on a screen based on image data by display unit; detecting a contact or proximity between a contact object and the display unit by proximity detection unit; detecting a rotation of the display unit in a plane parallel to the screen of the display unit; and zooming in or out an element displayed on the screen of the display unit and displaying the same on the screen depending on a rotation angle of the detected rotation by zoom processing unit while the contact or proximity is being detected.

According to the embodiments of the present invention, the image displayed on the display unit can be rapidly and easily zoomed in or out.

### BRIEF DESCRIPTION OF THE DRAWINGS

FIG. 1 is a block diagram showing an information processing apparatus according to one embodiment of the present invention;

FIG. 2 is a flowchart showing an operation of the information processing apparatus according to the embodiment;

FIG. 3 is a perspective diagram showing an appearance of the information processing apparatus according to the embodiment;

FIG. 4 is a front view showing a touch panel provided in the information processing apparatus according to the embodiment;

FIG. 5 is a front view showing a touch panel provided in the information processing apparatus according to the embodiment;

FIG. 6 is a front view showing a touch panel provided in the information processing apparatus according to the embodiment;

FIG. 7 is a front view showing a touch panel provided in the information processing apparatus according to the embodiment; and

FIG. 8 is a front view showing a touch panel provided in the information processing apparatus according to the embodiment.

### DETAILED DESCRIPTION OF PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. Structure of One Embodiment

### 2. Operation of One Embodiment

### 1. Structure of One Embodiment

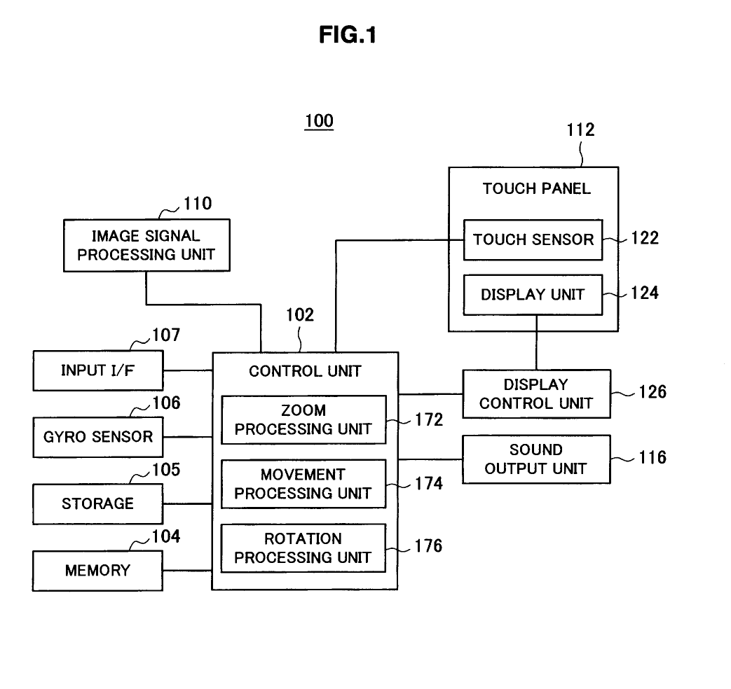

A structure of an information processing apparatus 100 according to one embodiment of the present invention will be described below. FIG. 1 is a block diagram showing the information processing apparatus 100 according to the present embodiment.

The information processing apparatus 100 according to the present embodiment includes a control unit 102, a memory 104, a storage 105, a gyro sensor 106, an input I/F 107, an image signal processing unit 110, a touch panel 112, a speech output I/F 116 and the like, for example.

The information processing apparatus 100 is a user-friendly portable personal computer, audio player, media player, PDA (personal digital assistant), cell phone, digital camera or the like, for example.

The control unit 102 has a microcomputer which is configured in combination with a CPU (Central Processing Unit), a ROM (Read Only Memory), a RAM (Random Access Memory) and the like. The control unit 102 functions as a calculation processing device and a control device by programs, and controls the above respective constituents in the information processing apparatus 100. A signal is input into the control unit 102 from the touch panel 112 receiving an operation from outside.

The memory 104 is configured with a storage unit such as RAM, ROM or cache memory, and has a function of temporarily storing therein data relating to the processing of the CPU of the control unit 102 or operation programs of the CPU.

The storage 105 is, for example, a hard disk, optical disk, flash memory or the like, and is a storage unit for storing therein data for a long time. The storage 105 stores therein music data or video data such as videos or photographs, for example. The storage 105 stores therein the music data or the video data through a data reception control processing and accumulation control processing in the control unit 102.

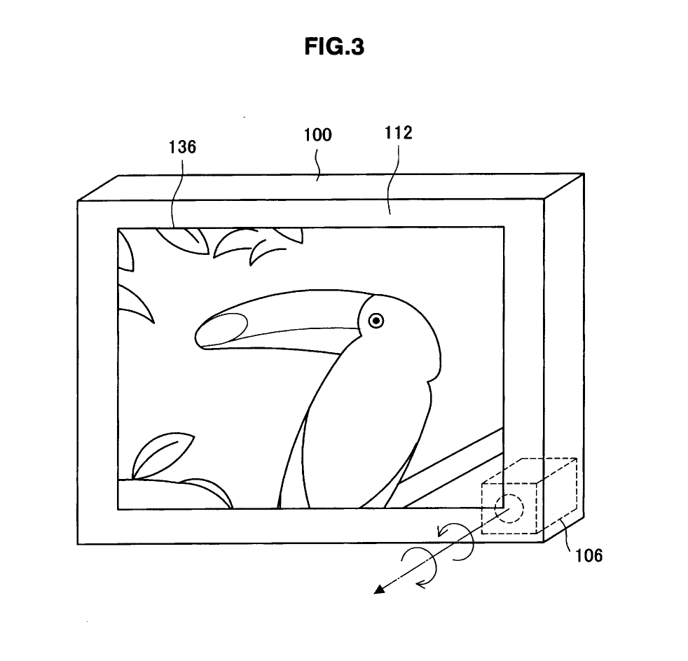

The gyro sensor 106 is one example of an angle detection unit, which detects a rotation of the touch panel 112 in a plane parallel to the screen of the touch panel 112. The gyro sensor 106 sends a detected rotation angle to the control unit 102. The gyro sensor 106 is provided inside the information processing apparatus 100 as shown in FIG. 3, and detects a rotation with the vertical direction relative to the screen of the touch panel 112 as an axis of rotation. FIG. 3 is a perspective diagram showing an appearance of the information processing apparatus 100 according to the present embodiment. The gyro sensor 106 is assumed to detect a rotation of the touch panel 112 in the present embodiment, but the present invention is not limited to the example. For example, a sensor capable of detecting rotations of more than one axis may be used or an acceleration sensor may be used.

The input I/F 107 is, for example, a USB terminal, IEEE 1394 terminal or the like, and is an interface which is connectable to an external device. Various items of information or instructions are input into the information processing apparatus 100 via the input I/F 107.

The image signal processing unit 110 decodes an image signal or performs a signal processing on the decoded image signal. The image signal processing unit 110 performs various required signal processings such as resolution conversion for converting an image signal into the number of pixels of the display unit 124, luminance correction, color correction and gamma correction.

The touch panel 112 includes a touch sensor 122, a display unit 124 and the like, and detects a contact on the screen of the display unit 124 to receive user's operation. Then, the touch panel 112 selects an item displayed on the screen, scrolls the screen or changes a display such as zoom-in or zoom-out display depending on a contact operation or contact position.

The display unit 124 is, for example, a liquid crystal display, an organic EL display or the like, and is controlled by a display control unit 126. The display unit 124 displays a menu screen for displaying a title of data or an image such as photograph or animation based on image data. The display control unit 126 uses an input image signal to drive the display unit 124. Thus, the image in response to the image signal is displayed on the screen of the display unit 124. The display control unit 126 reproduces the image signal received from the image signal processing unit 110. Further, the display control unit 126 combines the display data and generates user-viewable data in the display unit 124. The data generated in the display control unit 126 is output to the display unit 124.

The touch sensor 122 is a plane transparent member provided on the display unit 124. The touch sensor 122 detects a contact or proximity of a user's finger or an operator such as stylus pen (the contact and the proximity may be collectively referred to as contact below), or a contact position or proximity position (the contact position and the proximity position may be collectively referred to as contact position below). The touch sensor 122 is one example of a proximity detection unit. The contact position detected by the touch sensor 122 and the screen displayed on the display unit 124 are corresponded to each other. The structure and operation system of the touch panel 112 is resistive type or electrostatic capacitance type. The touch panel 112 can be configured to be realized by a typical technique and the detailed description thereof will be omitted. The touch panel 112 generates an operation signal based on the contact position or the like and sends the generated operation signal to the control unit 102. For example, the touch sensor 122 changes a display of the screen or moves the display position of a cursor displayed on the screen depending on the contact operation or the contact position.

The speech output I/F 116 is, for example, a terminal for a phone plug or the like, and is connected to an external device such as headphone or speaker. The speech output I/F 116 outputs reproduced speech data to the external device.

The control unit 102 in the information processing apparatus 100 according to the present embodiment will be described below. The control unit 102 further includes a zoom processing unit 172, a movement processing unit 174, a rotation processing unit 176 and the like.

The zoom processing unit 172 zooms in or out an image such as photograph or elements such as characters displayed on the touch panel 112 depending on the rotation angle detected in the gyro sensor 106. Then, the zoom processing unit 172 displays the zoomed-in or -out element on the touch panel 112. Thus, an image such as photograph or characters can be displayed larger or smaller than a typical size. The zoom processing unit 172 associates the rotation angle with the zoom magnification for zoom processing. For example, the right rotation corresponds to a large zoom-in magnification depending on the amount of rotation and the left rotation corresponds to a small zoom-out magnification depending on the amount of rotation.

The movement processing unit 174 moves an image such as photograph or elements such as characters displayed on the touch panel 112 depending on the contact or movement position detected in the touch sensor 122. Then, the movement processing unit 174 displays the element subjected to the movement processing on the touch panel 112. Thus, the image such as photograph or characters can be moved and displayed, and a part, which is out of the screen and may not be displayed, can be moved into the screen and displayed.

The rotation processing unit 176 performs a rotation processing on an image such as photograph or elements such as characters displayed on the touch panel 112 depending on the rotation angle detected in the gyro sensor 106. Then, the rotation processing unit 176 displays the rotated element on the touch panel 112. Thus, the image such as photograph or characters can be displayed to be constantly facing to the user. When the touch panel 112 is rotated in a plane parallel to the screen, if the rotation processing is not performed, the image or characters are oblique or vertical as viewed from the user. Thus, the rotation processing unit 176 rotates the image or characters in a direction opposite to the rotation direction of the touch panel 112 so that the image or characters can be displayed to be constantly horizontal as viewed from the user. The rotation processing by the rotation processing unit 176 and the zoom processing by the zoom processing unit 172 can be simultaneously performed, and the image or characters can be zoomed in or out while being rotated.

Further, when the zoom processing is completed, the rotation processing unit 176 performs the rotation processing on the rotated element with reference to the horizontal direction of the screen of the information processing apparatus 100 during the zoom mode. Thus, since the photograph or characters are horizontal in the screen, they are facing to the user when the information processing apparatus 100 is returned to the original orientation.

### 2. Operation of One Embodiment

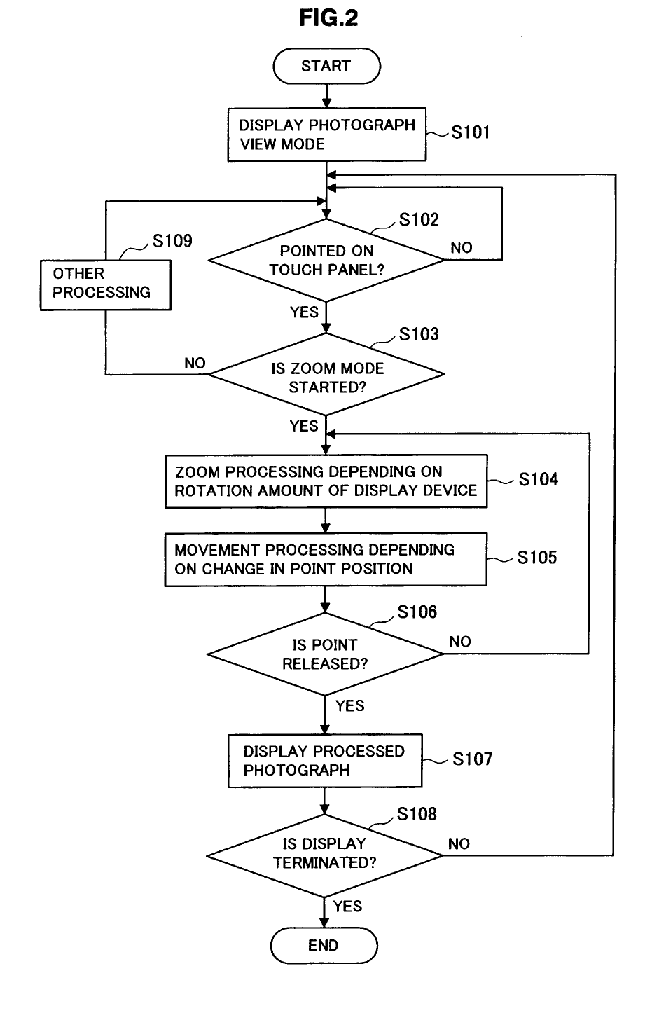

An operation of the information processing apparatus 100 according to the present embodiment will be described below. FIG. 2 is a flowchart showing the operation of the information processing apparatus 100 according to the present embodiment. Particularly, there will be described a case in which the information processing apparatus 100 is a portable device such as digital camera and an object such as photograph is zoomed in to be partially displayed or zoomed out to be displayed. For example, since a digital camera requires confirmation of a focus state of a taken photograph or confirmation of blurring, a primary part of the photographed object may be rapidly displayed in an enlarged manner. The present embodiment is effective for such a situation.

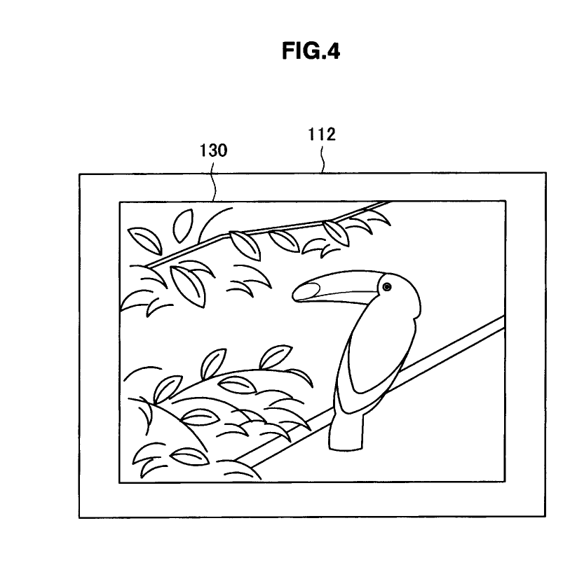

At first, in the information processing apparatus 100, a photograph view mode is selected through a user's operation and a photograph is displayed on the screen as shown in FIG. 4 (step S101). FIG. 4 is a front view showing the touch panel 112 provided in the information processing apparatus 100 according to the present embodiment. In FIG. 4, a photograph 130 is displayed on the touch panel 112. In the following, there will be described a case in which a display processing is performed on the photograph, but the display processing may be performed on an image other than photograph, or characters in the present invention.

The user points a reference point at the time of the zoom-in or zoom-out processing. The information processing apparatus 100 determines whether the touch panel 112 has been pointed through a contact or proximity by a user's finger or stylus pen (step S102). It is better that the user-pointed point is a position of particular interest in the photograph. When the user points the point, the information processing apparatus 100 determines whether to start the zoom mode (step S103). For example, after the user's contact or proximity to the touch panel 112 continues a predetermined period of time or more, the zoom mode is started. Thus, this is discriminated from other case in which the user's contact or proximity to the touch panel 112 intends other operation (such as pressing of button on the screen or drag&drop).

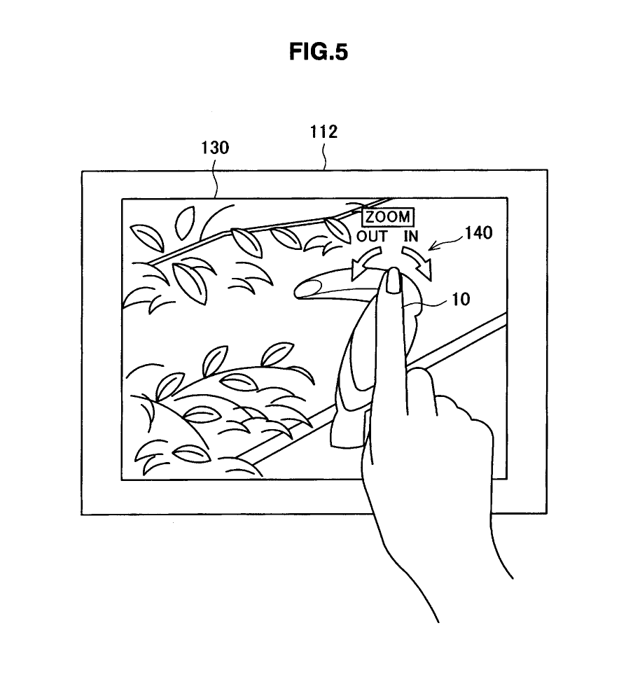

When the information processing apparatus 100 determines the start of the zoom mode, the processing proceeds to the zoom mode. For example, as shown in FIG. 5, the cursor 140 is preferably displayed on the pointed position on the screen. The cursor 140 in FIG. 5 indicates the zoom mode, which indicates that the zoom-in processing is performed by right rotation and the zoom-out processing is performed by left rotation with reference to the pointed position. FIG. 5 is a front view showing the touch panel 112 provided in the information processing apparatus 100 according to the present embodiment. FIG. 5 shows how a user's finger 10 points the touch panel 112, where the photograph 130 and the cursor 140 superimposed on the photograph 130 are displayed on the touch panel 112.

On the other hand, when the user's contact or proximity to the touch panel 112 continues less than a predetermined period of time and other operation is performed, a processing other than the zoom processing is performed (step S109).

After the zoom mode is started, while the user's contact or proximity to the touch panel 112 is being continued, the user rotates the information processing apparatus 100 itself in a plane parallel to the screen of the touch panel 112 so that the photograph on the screen is zoomed in or out to be displayed. At this time, the zoom processing is performed on the photograph depending on the amount of change in the rotation (rotation angle) detected by the gyro sensor 106 provided in the information processing apparatus 100 (step S104). When a rotation is detected, the zoom-in processing is performed by right rotation and the zoom-out processing is performed by left rotation with reference to the pointed position. At this time, the reference point does not move due to the zoom processing.

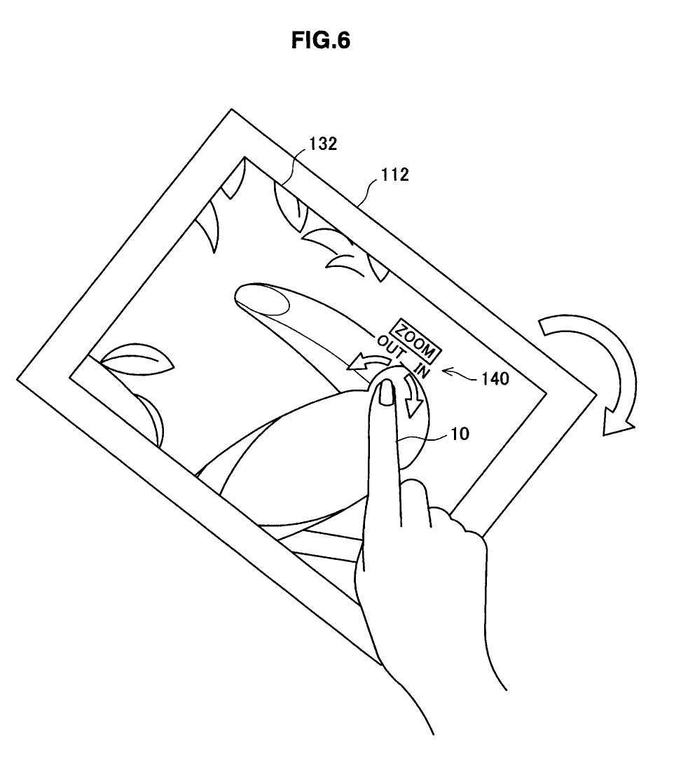

When right rotation is made in the information processing apparatus 100, a photograph 132 in FIG. 6, to which the photograph 130 shown in FIGS. 4 and 5 is zoomed up, is displayed on the touch panel 112. FIG. 6 is a front view showing the touch panel 112 provided in the information processing apparatus 100 according to the present embodiment. FIG. 6 shows how the user's finger 10 points the touch panel 112, where the enlarged photograph 132 and the cursor 140 superimposed on the photograph 132 are displayed on the touch panel 112.

A limit value may be set for the zoom processing depending on a rotation. In other words, there may be set a range in which the image can be zoomed in or out.

Next, during the zoom mode, while the user's contact or proximity to the touch panel 112 is being continued, the user drags the finger 10 so that the entire photograph moves along with the movement of the finger 10. The information processing apparatus 100 detects the contact or proximity to the touch panel 112 and moves the photograph depending on a change in the user-pointed position (step S105).

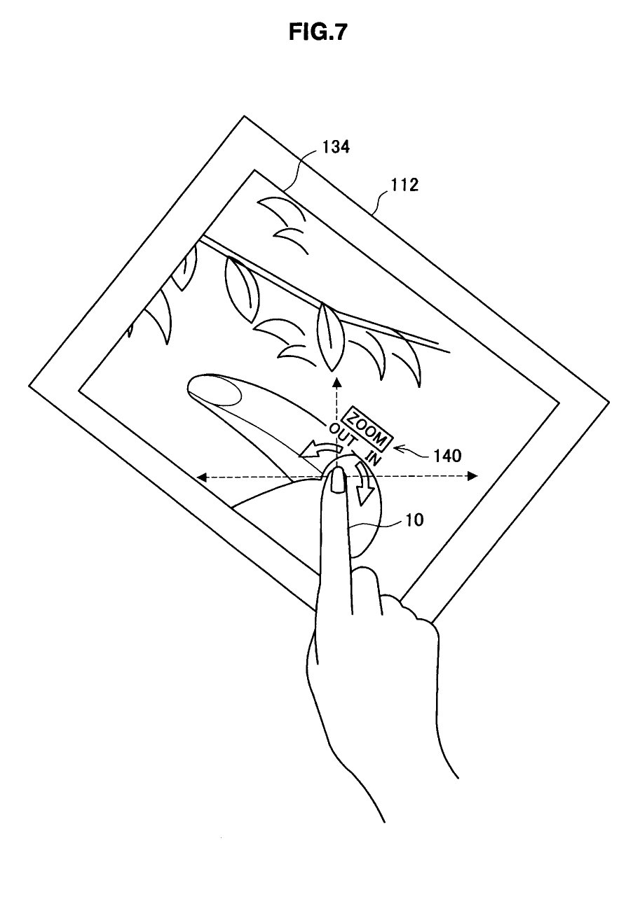

When the contact position by the finger 10 is changed on the touch panel 112 of the information processing apparatus 100, the enlarged photograph 132 shown in FIG. 6 is moved as shown in FIG. 7 so that a photograph 134 is displayed on the touch panel 112. FIG. 7 is a front view showing the touch panel 112 provided in the information processing apparatus 100 according to the present embodiment. FIG. 7 shows how the user's finger 10 points the touch panel 112, where the moved photograph 134 and the cursor 140 superimposed on the photograph 134 are displayed on the touch panel 112.

After the zoom mode is started, even when the movement processing is performed, the cursor 140 is continuously being displayed while the user's contact or proximity is being continued. Then, the user can further rotate the information processing apparatus 100 at the moved position to further zoom in or out the photograph 134. The information processing apparatus 100 determines whether the user's point on the touch panel 112 has been released (step S106). Until the point is released, the zoom processing or the movement processing can be repeatedly performed on the photograph.

When the point is released, as shown in FIG. 3, a photograph 136 subjected to the zoom processing or the movement processing is displayed on the touch panel 112 (step S107). In FIG. 3, after the photograph 132 subjected to the zoom-in processing shown in FIG. 6 or the photograph 134 subjected to the movement processing shown in FIG. 7 is displayed, the orientation of the information processing apparatus 100 is returned to the original by the user and the photograph 136 subjected to the zoom processing or the movement processing is finally displayed.

After the processed photograph is displayed, the information processing apparatus 100 determines whether the display processing has terminated in the photograph view mode (step S108). Until the display processing terminates, a user's point is further accepted on the touch panel 112, thereby performing again the display processing such as the zoom processing.

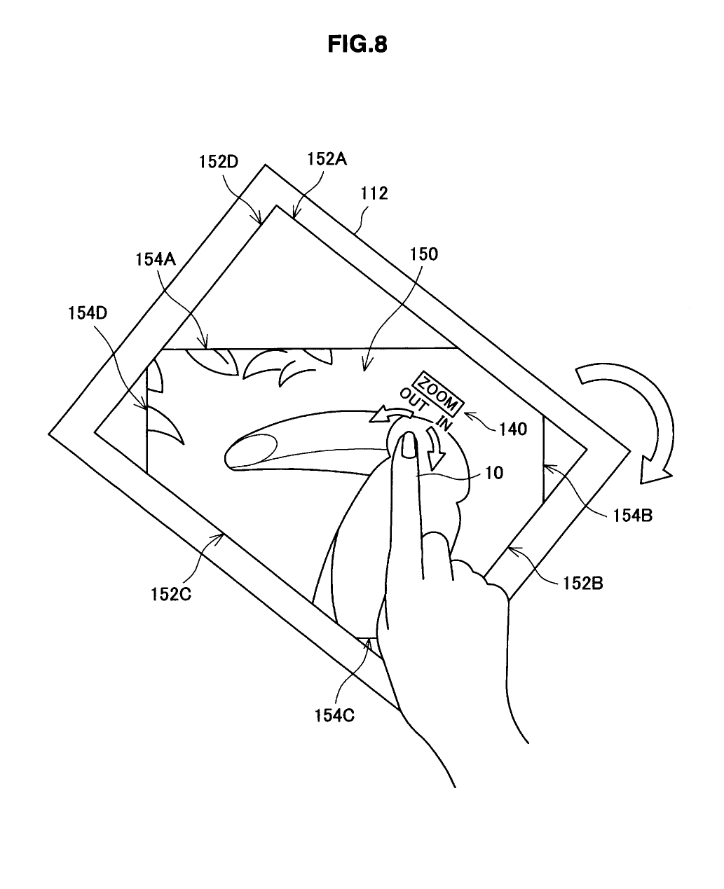

In the above embodiment, the displayed contents (such as photograph) on the touch panel 112 are rotated along with the rotation of the information processing apparatus 100 as viewed from the user. In other words, when the touch panel 112 is rotated in a plane parallel to the screen, if the rotation processing is not performed on the displayed contents, the image or characters are oblique or vertical as viewed from the user. Thus, the rotation processing unit 176 of the information processing apparatus 100 performs the rotation processing of rotating an image or characters in an opposite direction to the rotation direction of the touch panel 112, thereby constantly displaying the image or characters to be horizontal as viewed from the user. FIG. 8 shows a photograph 150 subjected to the rotation processing in a direction facing to the user while the zoom-in processing is being performed on the photograph 130 shown in FIG. 5.

Then, when the user's point is released in step S106 to complete the zoom processing, the displayed contents which has been subjected to the rotation processing is rotated with reference to the horizontal direction of the screen of the information processing apparatus 100 during the zoom mode. Thus, since the photograph 136 or the characters are horizontal in the screen as shown in FIG. 3, when the information processing apparatus 100 is returned to the original orientation, it faces to the user.

When the rotation processing unit 176 performs the rotation processing of rotating an image or characters in the opposite direction to the rotation direction of the touch panel 112, the information processing apparatus 100 may present a size of the photograph at the original orientation of the information processing apparatus 100 to the user as shown in FIG. 8. FIG. 8 is a front view showing the touch panel 112 provided in the information processing apparatus 100 according to the present embodiment. FIG. 8 shows how the user's finger 10 points the touch panel 112, where a photograph 150 subjected to the zoom processing and the rotation processing and the cursor 140 superimposed on the photograph 150 are displayed on the touch panel 112.

Then, frames 152A, 152B, 152C and 152D are displayed in the photograph view mode on the touch panel 112. Frames 154A, 154B, 154C and 154D are displayed also for the rotated photograph 150. Thus, a position or relative size of the photograph is made clear when the user's point is released in step S106 to complete the zoom processing and the photograph 136 is horizontal in the screen as shown in FIG. 3.

Since the zoom-in processing has been performed with reference to the center of the image in the image zoom-in processing in related art, when the zoom-in processing is performed with reference to an arbitrary point (such as point near an edge of the photograph other than the center thereof) in a photograph, several steps are required for the zoom-in processing and the movement processing. On the other hand, according to the present embodiment, the zoom-in processing can be performed through the two steps of the pointing to the touch panel 112 and the rotation of the information processing apparatus 100 itself. Consequently, the image zoom processing can be rapidly and easily performed with reference to an arbitrary point.

The above operation assumes a lens zoom operation at the time of the photography by a camera and the user can intuitively operate the zoom processing. Since the zoom processing is performed only on the touch panel 112 provided in the information processing apparatus 100, any buttons are not required to be additionally installed in the information processing apparatus 100, thereby sizing down the information processing apparatus 100. Furthermore, displays other than the cursor 140 do not need to be additionally displayed on the screen of the touch panel 112. Thus, a photograph can be mainly displayed to be simply and excellently displayed even for GUI (graphic user interface).

The present application contains subject matter related to that disclosed in Japanese Priority Patent Application JP 2008-221859 filed in the Japan Patent Office on Aug. 29, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a display unit that displays an image on a screen based on image data;
a proximity detection unit that detects a contact or proximity between a contact object and the display unit;
an angle detection unit that detects a rotation of the display unit in a plane parallel to the screen of the display unit; and
a zoom processing unit that zooms in or out an element displayed on the screen of the display unit and displays the same on the screen depending on a rotation angle of the detected rotation while the contact or proximity is being detected.

2. The information processing apparatus according to claim 1, wherein the zoom processing unit zooms in or out the element with reference to a position of the detected contact or proximity on the screen.

3. The information processing apparatus according to claim 1, comprising a movement processing unit that moves an element displayed on the screen of the display unit and displays the same on the screen depending on a change in a position of the detected contact or proximity while the contact or proximity is being detected.

4. The information processing apparatus according to claim 1, comprising a rotation processing unit that rotates an element displayed on the screen of the display unit and displays the same on the screen depending on a rotation angle of the detected rotation while the contact or proximity is being detected.

5. The information processing apparatus according to claim 1, wherein when a predetermined time elapses after the proximity detection unit detects the contact or proximity, the zoom processing unit starts a zoom mode capable of zooming in or out the element.

6. An information processing method comprising the steps of:
displaying an image on a screen based on image data by display unit;
detecting a contact or proximity between a contact object and the display unit by proximity detection unit;
detecting a rotation of the display unit in a plane parallel to the screen of the display unit; and
zooming in or out an element displayed on the screen of the display unit and displaying the same on the screen depending on a rotation angle of the detected rotation by zoom processing unit while the contact or proximity is being detected.
